(19) United States
(12) Patent Application Publication
(10) Pub. No.: US 2013/0010459 A1
(43) Pub. Date: Jan. 10, 2013

(54) LED TUBE LAMP

(76) Inventor: David M. Wilson, Carbondale, IL (US)

(21) Appl. No.: 13/542,304

(22) Filed: Jul. 5, 2012

Related U.S. Application Data
(60) Provisional application No. 61/504,962, filed on Jul. 6, 2011.

(51) Int. Cl. F21V 21/005; F21V 11/02; F21V 29/00

(52) U.S. Cl. 362/217.02; 362/217.13

(57) ABSTRACT

A LED tube lamp having a base defining a channel and a driver mounted within the channel. A lighting circuit removeably attaches to the base and operatively connects to the driver. A cover removeably attaches to the base. A connector removeably attaches to the base and cover, the connector being operatively connected to the lighting circuit.

### CROSS-REFERENCE TO RELATED APPLICATIONS

This Non-Provisional application claims priority to U.S. Provisional Application Ser. No. 61/504,962 filed Jul. 6, 2011, and which is incorporated herein by reference.

### STATEMENT REGARDING FEDERALLY SPONSORED RESEARCH

Not Applicable.

### BACKGROUND

The present invention generally relates to a light emitting diode (LED) tube lamp, and more particularly to a LED lamp capable of replacing a fluorescent tube lamp.

As a result of government regulation, the traditional incandescent light bulb is being phased out of use. Currently, two main alternatives are available to consumers as a replacement for the incandescent light bulb: compact fluorescent light (CFL) and light emitting diode (LED).

LED light bulbs have many advantages over CFL bulbs. For instance, LED bulbs use less power. They contain no mercury. They turn on instantly without the need for any warm-up. Their lifetime is unaffected by cycling on and off. They are not affected by temperature changes or humidity changes in the atmosphere and their solid state design makes them less likely to break.

However, LED light bulbs must be designed to work in existing light fixtures. One popular type of light fixture use fluorescent tube bulbs. Therefore, what is needed is a LED light bulb capable of replacing a fluorescent tube bulb.

### DESCRIPTION OF THE DRAWINGS

In the accompanying drawings which form part of the specification:

FIG. 1 is a side view of a LED tube lamp;

FIG. 2A is a perspective exploded view of a LED tube lamp;

FIG. 2B is a partial side view of the LED tube lamp;

FIG. 3 is a perspective section view of the LED tube lamp;

FIG. 4A is a partial plan view of a printed circuit board of the LED tube lamp;

FIG. 4B is an end view of the printed circuit board of the LED tube lamp;

FIG. 5 is a partial plan view of a first alternate embodiment of a connectable printed circuit board;

FIG. 6 is an end view of a base of the tube LED lamp;

FIG. 7 is an end view of the cover of the LED tube lamp;

FIG. 8 is a rear view of the end cap of the LED tube lamp;

FIG. 9 is a side view of the end cap of the LED tube lamp;

FIG. 10 is a front view of the end cap of the LED tube lamp;

FIG. 11 is a section view of the pin along a center axis;

FIG. 12 is a top view of a plate of the LED tube lamp;

FIG. 13 is a bottom view of the plate of the LED tube lamp;

FIG. 14 is a side view of a granule of the LED tube lamp;

FIG. 15 is a top view of the granule of the LED tube lamp;

FIG. 16 is perspective view of a light fixture;

FIG. 17 is perspective view of a LED tube lamp engaging a socket of the light fixture;

FIG. 18 is top view of an alternate embodiment of the LED tube lamp;

FIG. 19 is an exploded end perspective view of an alternate embodiment of the end connector;

FIG. 20 is a schematic of an LED driver circuit;

FIG. 21 is plan view of a second alternate embodiment of a printed circuit board;

FIG. 22 is a plan view of a third alternate embodiment of a printed circuit board;

FIG. 23 is an plan view of an fourth alternate embodiment of a printed circuit board; and

FIG. 24 is a plan view of a fifth printed circuit board.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

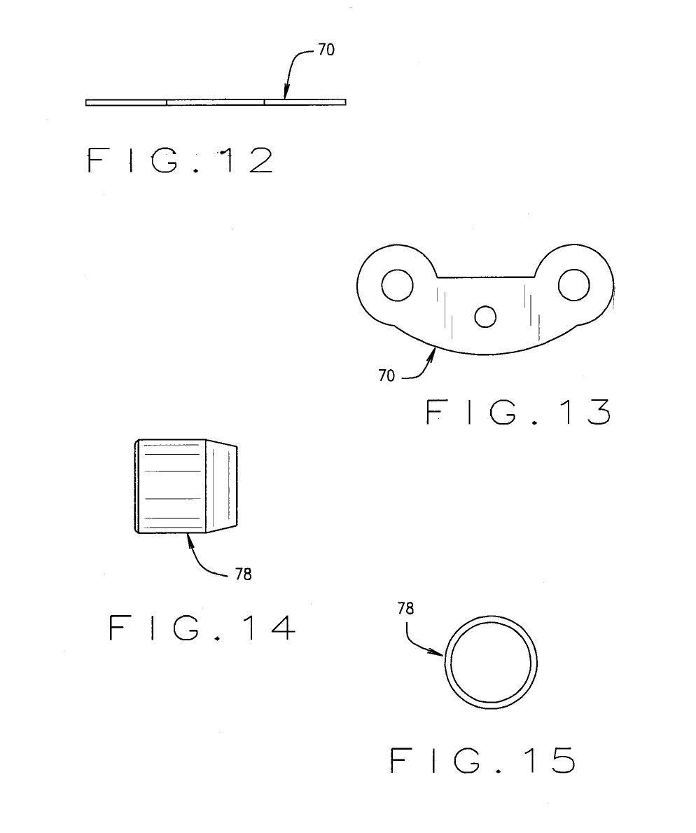

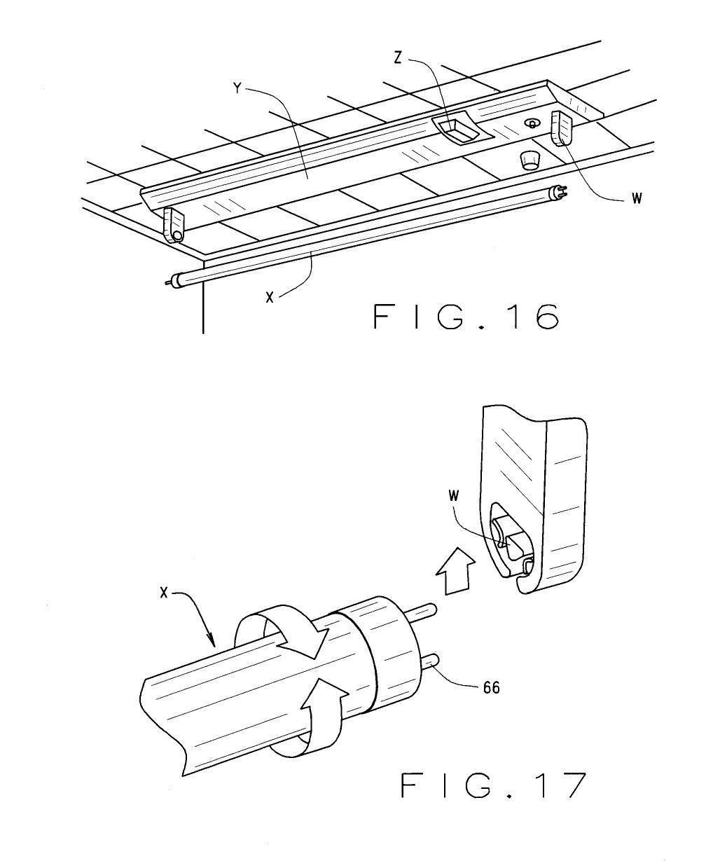

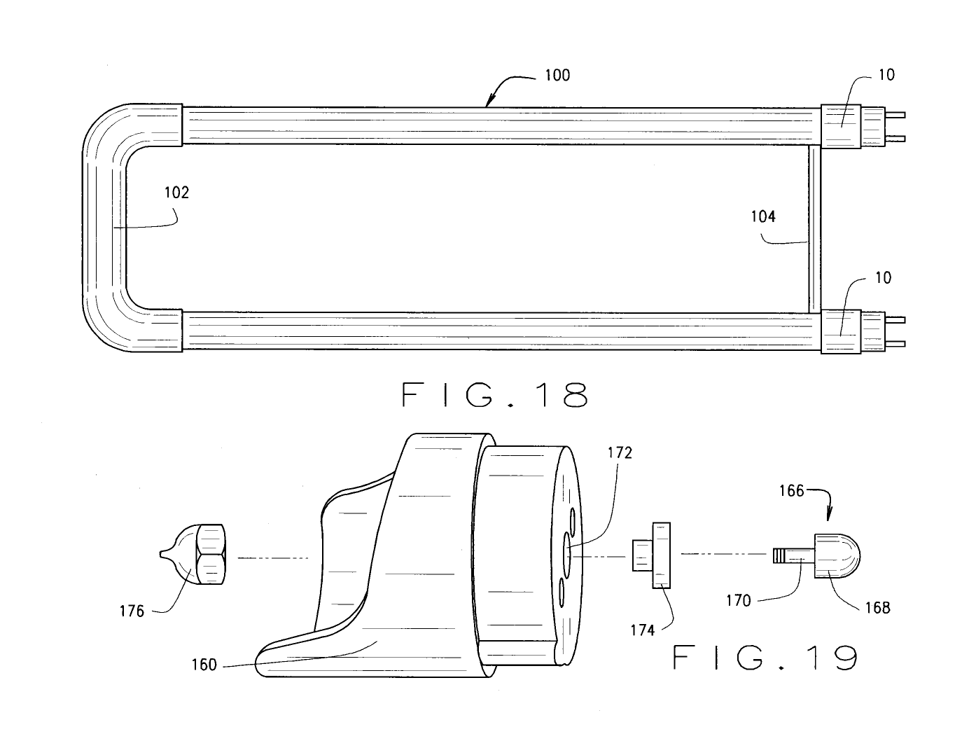

As shown in FIGS. 1-20, an embodiment constructed in accordance with the present disclosure, generally referred to as a LED lamp 10, includes a lighting circuit 12 mounted within a tube-shaped housing 14. The lighting circuit 12 operatively connects to connectors 16 at each end of the housing 14. The connectors 16 are shaped and sized for removeable mounting to a light fixture. The LED lamp 10 can replace fluorescent tube lamps X in as fluorescent fixture Y. Furthermore, the LED lamp 10 can be disassembled and reassembled to permit repair and refurbishment.

The LED lamp 10 should be sized and shaped for installation into a corresponding fluorescent fixture Y (FIG. 16). Typically, fluorescent fixtures have various standard sizes indicated by their length, such as, 2 ft, 3 ft, etc. The LED lamp 10 can be sized accordingly to correspond to any length fixture.

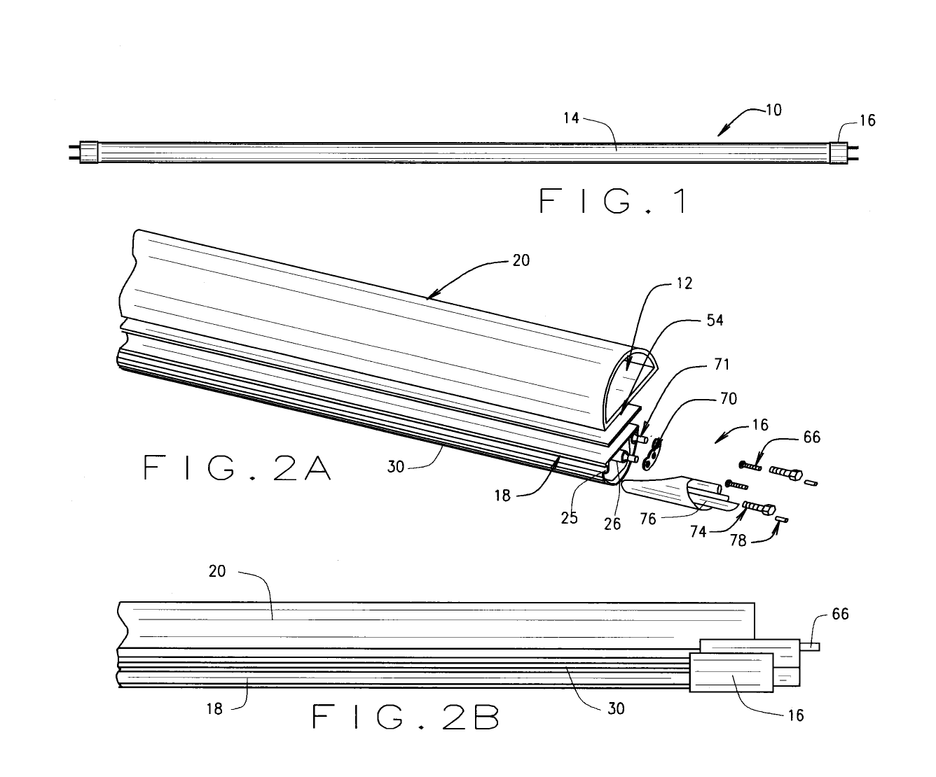

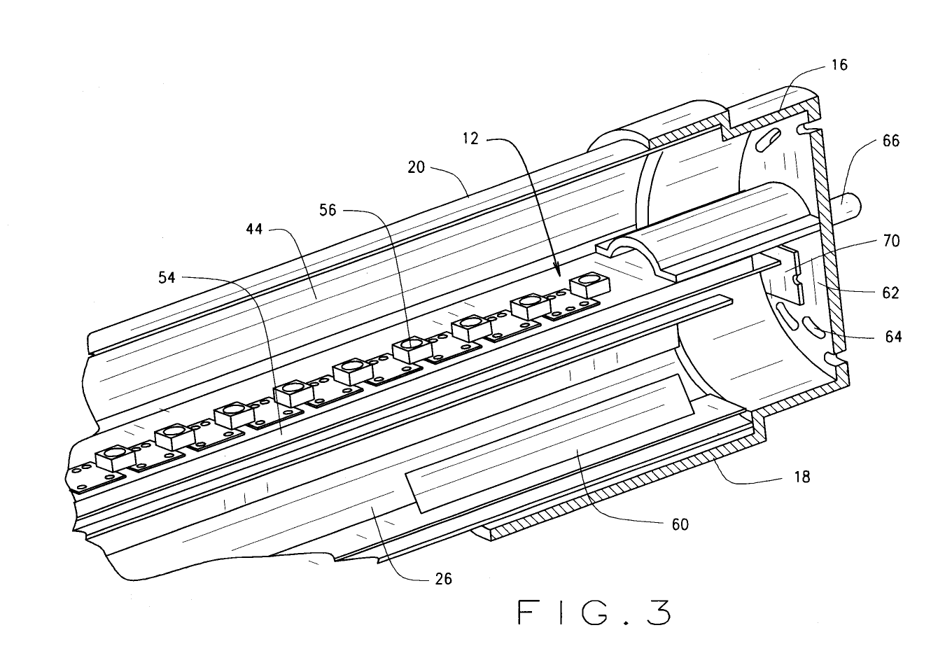

The housing 14 includes a base 18 sized and shaped for removeable mounting of the lighting circuit 12. (FIGS. 2A-3). Also, the housing 14 includes a generally translucent cover 20 sized and shaped for removeable mounting to the base 18.

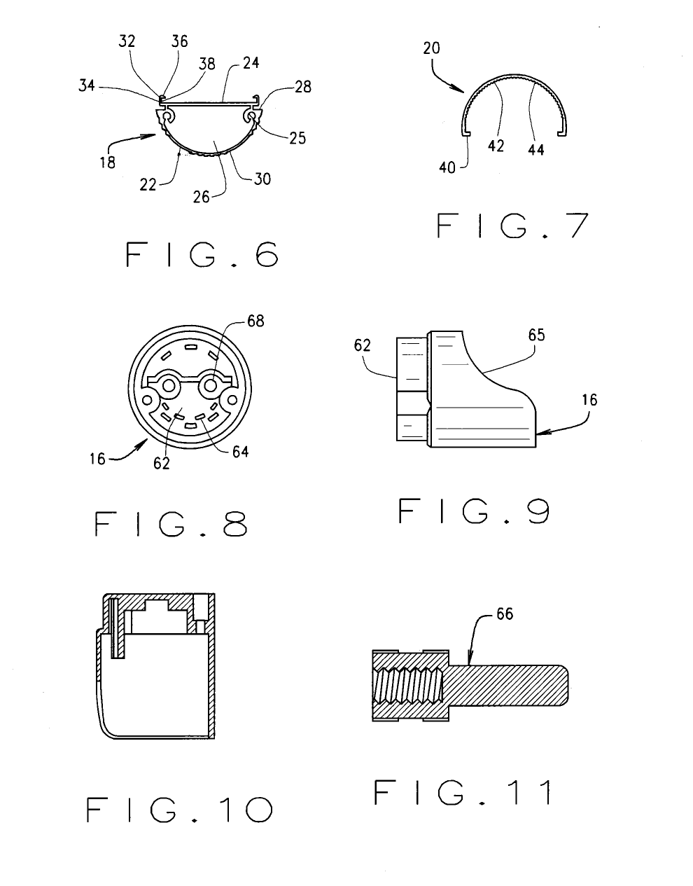

The base 18 is a linear tube with a generally semi-circular cross-section from an end view perspective (FIG. 6). The base 18 includes an arcuate lower portion 22 and a planar upper portion 24, which define an internal channel 26. At each end of the base 18, threaded tabs 25 are defined within the channel 26 at the intersections of the lower portion 22 and upper portion 24. The threaded tabs 25 are sized and shaped to receive fasteners 26 for attaching the connectors 16. The base 18 defines a longitudinal outer groove 28 along the intersection of the lower portion 22 and the upper portion 24. The groove 28 is sized and shaped to receive the cover 20. Longitudinal ribs or fins 30 extend along the lower portion 22 of the base 18. The fins 30 are shaped and sized to increase convective heat transfer from the base 18 to the surrounding atmosphere. The base 18 is preferably made from a metal, such as aluminum, but can also be made from any suitable material, including, but not limited to carbon fiber, steel, stainless steel, nickel-plated steel, copper-plated steel, non-metallic materials, and the like.

Each longitudinal edge of the upper portion 24 defines a retaining member 32. Each retaining member 32 includes a rib 34 extending generally perpendicularly from the edge and terminating in an inwardly facing wedge 36, thereby defining a slot 38 sized and shaped to receive the lighting circuit 12. Initially, the span between the retaining members 32 is smaller than the width of the lighting circuit 12. However, the retaining members 32 possess enough elasticity to permit movement apart from each other to increase the span. To assemble the lighting circuit 12 with the base 18, the lighting circuit 12 presses downward against the wedges 36, which moves the wedges 36 outwardly, thereby increasing the span until the span is larger than the width of the lighting circuit 12. The lighting circuit 12 inserts into the slot 38 and the retaining members 32 return to their original position. (FIG. 2A)

The cover 20 is a linear strip having a generally semi-circular cross section. A rib 40 extends generally inwardly from each edge of the cover 20. (FIG. 7). The ribs 40 are sized and shaped to seat within the outer groove 28 of the base 18. The cover inner surface 42 defines a diffusion pattern 44 for diffusion of the light emitted from the lighting circuit 12. In the embodiment of FIGS. 1-24, the diffusion pattern 44 is a plurality of longitudinal ribs along the inner surface 42. However, any suitable pattern can be used that effectively diffuses the light emitted from the lighting circuit 12. In addition, the diffusion pattern 44 can alternately be defined on the outer surface of the cover 20. The cover 20 is preferably made from a polymer material, such as acrylic. However, any suitable material can be used, including, but not limited to, glass, or composite materials. For installation of the cover 20 onto the base 18, the cover 20 is made from a material that is elastic enough to allow the ribs 40 to expand over the retaining members of the base 18 and retract into the outer grooves 28 of the base 18. If desired, the cover 20 can be made of a phosphorescent material, such as, acriglo photoluminescent or magnesium strontium silicate phosphorescent blue acrylic. Using phosphorescent materials would allow the cover 20 to temporarily glow during a outage.

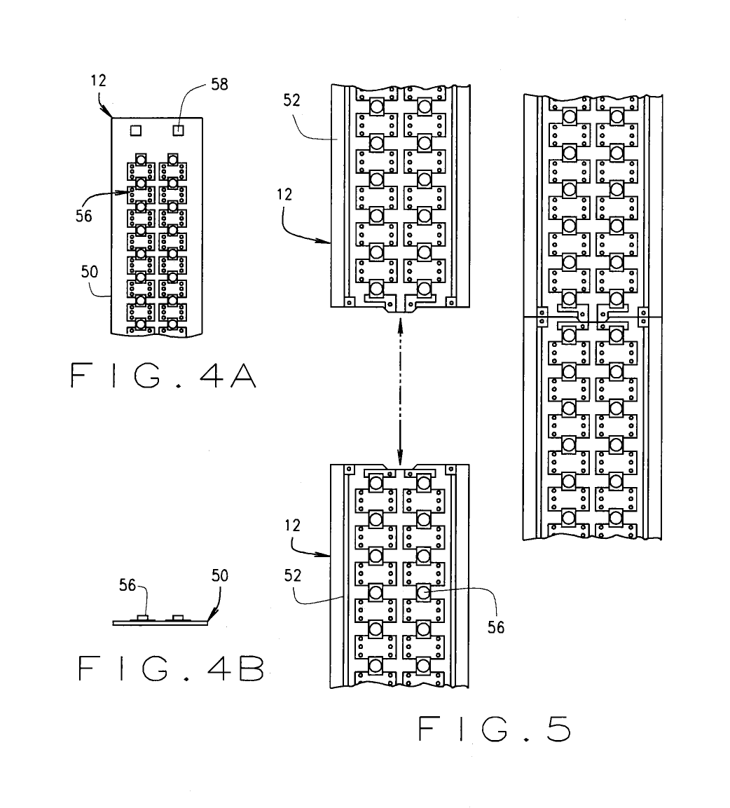

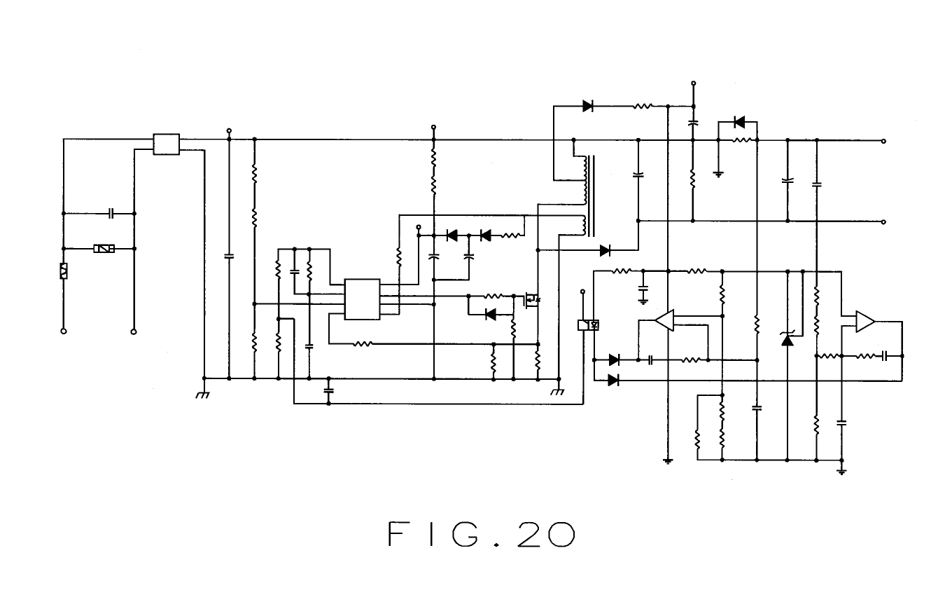

The lighting circuit 12 includes a printed circuit board 50 sized and shaped for seating against the upper portion 24 of the base 18 and securement within the slot 38 by the retaining members 32. (FIGS. 4A-4B). In an alternate embodiment, the circuit board 50 can include a plurality of connectable circuit boards 52. (FIG. 5). A thermal transfer layer 54 is interposed between the circuit board 50 and the base 18 to aid heat transfer. (FIG. 2A). The thermal transfer layer 54 is preferably a thermal conductive adhesive. However, any suitable thermal transfer medium can be used, including but not limited to, ceramic-based thermal grease, metal-based thermal grease, carbon-based, thermal grease, liquid metal-based thermal grease, silicone-based thermal compound, non-silicone thermal compound, and the like. A plurality of LED's 56 are mounted on the circuit board 50 in an array and operatively connected to contacts 58 at each end of the circuit board 50. (FIG. 2A). A LED driver 60 is mounted within the channel 26 of the base 18 and is operatively connected to the circuit board 50. The driver 60 is a self-contained power supply that provides constant current or constant voltage to the LED array 56 in order to maintain a constant luminous output. If desired, the driver 60 may also offer dimming by means of pulse width modulation (PWM) circuits or other suitable method. Preferably, the driver 60 includes a coating that provides desired properties, such as flame retardant, water resistant, or waterproof properties. The coating can comprise any suitable material, such as varnish V0 material, or nano-coating. FIG. 20 shows a schematic of the driver 60. However, any suitable LED driver can be used, including, but not limited to, any commercially available LED drivers.

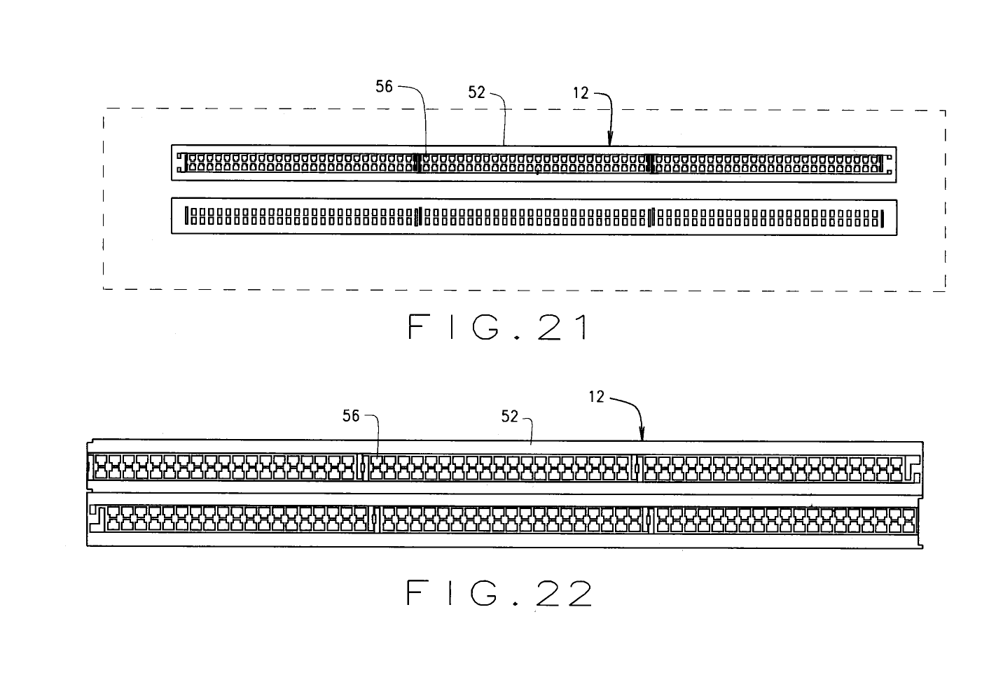

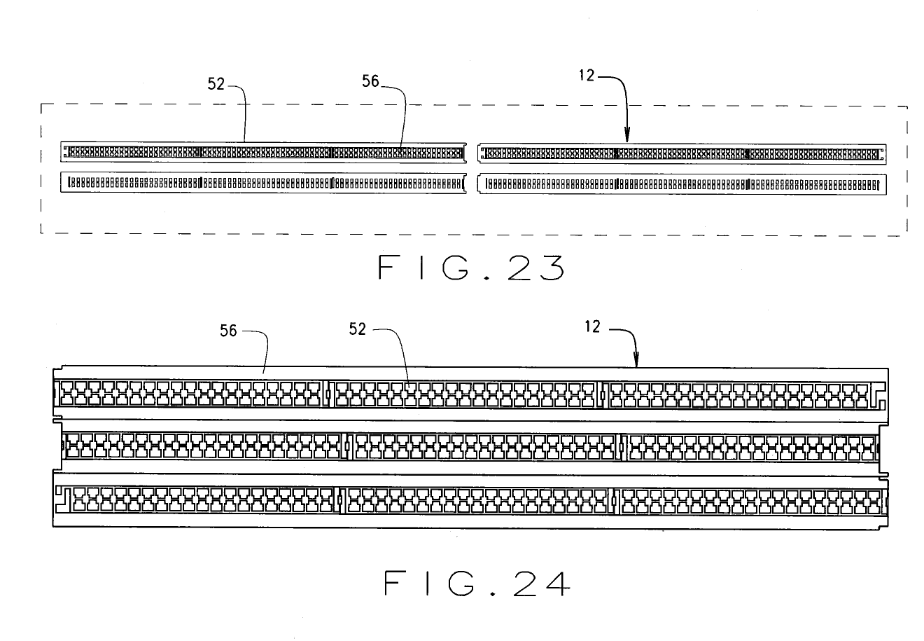

FIGS. 21-24 show printed circuit boards configured for various size LED lamps 10, which generally correlate with industry standard T8 sizes. FIG. 21 shows a circuit board 50 for a two foot T8 lamp 10 having 162 LED's 56 configured with twenty seven LED's to a series and with six parallels. FIG. 22 shows a circuit board 50 for a three foot T8 lamp 10 having 240 LED's 56 configured with twenty LED's to a series and with twelve parallels. FIG. 23 shows a circuit board 50 for a four foot T8 lamp 10 having 324 LED's 56 configured with twenty seven LED's to a series and with twelve parallels. FIG. 24 shows a circuit board 50 for a five foot T8 lamp 10 having 360 LED's 56 configured with thirty LED's to a series and with twelve parallels. The LED lamps 10 can also comprise other configurations. For example, a circuit board 50 for a six foot T8 lamp 10 can have 486 LED's 56 configured with twenty seven LED's to a series and with eighteen parallels. In addition, a circuit board 50 for a eight foot T8 lamp 10 can have 648 LED's 56 configured with twenty seven LED's to a series and with twenty four parallels.

Other LED lamp 10 and circuit board 50 configurations include but are limited to:

a circuit board 50 for a four foot lamp 10 having 312 LED's 56 configured with twelve LED's to a series and with twenty-six parallels (20 mA per parallel), having end connectors 60 with bi-pin (G13), single pin (Fa8), or H.O. Pin (Recessed Double Contact (R17d));

a circuit board 50 for a four foot lamp 10 having 336 LED's 56 configured with twelve LED's to a series and twenty-eight parallels (18.5 mA per parallel), having end connectors 60 with bi-pin (G13), single pin (Fa8), or H.O. Pin (Recessed Double Contact (R17d);

a circuit board 50 for a two foot lamp 10 having 156 LED's configured with twelve LED's to a series and thirteen parallels (20 mA per parallel), having end connectors 60 with bi-pin (G13), single pin (Fa8), or H.O. Pin (Recessed Double Contact (R17d);

a circuit board 50 for a two foot lamp 10 having 168 LED's configured with twelve LED's to a series and fourteen parallels (18.5 mA per parallel), having end connectors 60 with bi-pin (G13), single pin (Fa8), or H.O. Pin (Recessed Double Contact (R17d);

a circuit board 50 for a five foot lamp 10 having 432 LED's configured with twelve LED's to a series and thirty-six parallels (18 mA per parallel), having end connectors 60 with bi-pin (G13), single pin (Fa8), or H.O. Pin (Recessed Double Contact (R17d);

a circuit board 50 for an eight foot lamp 10 having 624 LED's configured with twelve LED's to a series and fifty-six parallels (20 mA per parallel), having end connectors 60 with bi-pin (G13), single pin (Fa8), or H.O. Pin (Recessed Double Contact (R17d);

a circuit board 50 for an three foot lamp 10 having 240 LED's configured with twelve LED's to a series and twenty parallels, having end connectors 60 with bi-pin (G13), single pin (Fa8), or H.O. Pin (Recessed Double Contact (R17d); and

a circuit board 50 for an six foot lamp 10 having 504 LED's configured with twelve LED's to a series and forty-two parallels, having end connectors 60 with bi-pin (G13), single pin (Fa8), or H.O. Pin (Recessed Double Contact (R17d).

Each connector 16 is generally a cylinder with one closed end 62 that defines a socket 65 sized and shaped to receive the assembled base 18, lighting circuit 12, and cover 20. (FIGS. 8-10). The closed end 62 defines vents 64 shaped and sized to allow the dissipation of heat from the inside of the LED lamp 10 to the surrounding atmosphere. Pins 66 extend through holes 68 in the closed end 62 and are secured to a contact plate 70 with fasteners 72. The pins 66 extend outwardly from the closed end 62 a predetermined distance for engagement with the light fixture Y. (FIG. 17). The contact plate 70 is sized and shaped to electrically connect the pins 66 to the contacts 58 of the circuit board 50 when assembled. (FIGS. 16-17). Preferably, the contact plate 70 is made of copper, but any electrically conductive material can be used. The contact plate 70 mounts to the inner surface of the closed end 62 of the connector 16 with fasteners 71. To assemble, each end of the assembled base 18, lighting circuit 12, and cover 20 insert into the connecter socket 64 and seat against the closed end 62. (FIG. 2A). Fasteners 74 insert through counterbored holes 76 and secure to respective threaded tabs 25 of the base 18. Granules 78 insert into respective counterbored holes 76 to conceal the fasteners 74.

To assemble the LED lamp 10, the thermal transfer layer 54 mounts to the upper portion 24 of the base 18. The circuit board 50 presses onto the retaining members 32 until it snaps into the slot 38. The cover 20 presses onto the base 18 until the ribs 40 snap into the grooves 28 of the base 18. Each connector 16 slides over respective ends of the assembled base 18, cover 20, and circuit board 50 and is secured with fasteners 74. Each connector 16 is operatively connected to the contacts 58 of the circuit board 50 and the driver 60.

Preferably, the LED lamp 10 and any of the components includes a coating that provides desired properties, such as flame retardant, water resistant, or waterproof properties. The coating can comprise any suitable material, such as varnish, V0 material, or nano coating.

In operation, the LED lamp 10 is a replacement for a fluorescent tube lamp in a light fixture. (FIGS. 16-17). The fluorescent tube lamp X is removed from the light fixture Y and the ballast Z disconnected. Then, the LED lamp 10 is installed in the light fixture Y with each connector coupling with respective sockets W of the light fixture Y. Preferably, the LED lamp 10 operates within a voltage range of about 100-277 VAC. However, any suitable voltage range can be used.

An alternate embodiment of the LED lamp 100 is shown in FIG. 22. This U-shaped LED lamp 100 includes a pair of parallel lamps 10 connected by a U-shaped connecter 102 at one end. A support member 104 attaches between the lamps 10 at the opposite end for stability.

Another alternate embodiment of the LED lamp 100 is shown in FIGS. 25-29, which includes an alternate end connector 160. Instead of using a pair of pins 66 to electrically connect the pins 66 to the contacts 58 of the circuit board 50, the alternate end connector 160 uses a single peg 166 with a rounded end 168 that is shaped and sized to engage with a slimline type light fixture Y. The peg 166 has a threaded end 170 sized and shaped to insert into the center hole 172 of the end connector 166 and secured with fasteners, such as a bushing 174 and nut 176. However, any suitable fasteners can be used. Those skilled in the art will recognize that the end connector can have other configurations, including but not limited to a high output socket configuration, or a four pin 2G11 configuration. Alternatively, the LED lamp can comprise a modular design using spade connections to connect the driver to the circuit board 50 and end connectors 160.

In another alternate embodiment, the LED lamp 10 can include a backup power source operatively connected to the lighting circuit 12 to provide a secondary power source in the event that main power is lost. The backup power source can include a capacitor, battery, or other suitable power source that can be positioned within the housing 14.

If desired, the LED lamp 10 can include indicia for identification purposes. For example, the end connectors 166 can be marked using an appropriate method, such as laser etching, with a date code or other desired information.

The LED lamp can comprise a number of different wiring configurations. For example, one wiring configuration defines the LED lamp 10 with a hot contact at one end and a neutral contact at the opposite end (about 120 or 277 VAC). In an alternate wiring configuration, the LED lamp 10 includes a pair of hot contacts of opposite phase (240V or 208V) at opposite ends of lamp. In yet another alternate wiring configuration, the LED lamp 10 includes a hot contact and and a neutral contact adjacent to each other on one end. Additionally, the LED lamp 10 can include a pair of hot contacts of opposite phase adjacent to each other on one end. Also, wiring configuration defines the LED lamp 10 with a hot contact and a neutral contact at both ends with socket conductors closed. In addition, the LED lamp 10 can include a circuit-Interrupting lampholder on one end for wiring configuration.

Changes can be made in the above constructions without departing from the scope of the disclosure, it is intended that all matter contained in the above description or shown in the accompanying drawings shall be interpreted as illustrative and not in a limiting sense.

1. A LED tube lamp, comprising:
a base defining a channel;
a driver mounted within the channel;
a lighting circuit removeably attached to the base and operatively connected to the driver;
a cover removeably attached to the base; and
a connector removeably attached to the base and cover, the connector being operatively connected to the lighting circuit and the driver.

2. (canceled)

3. The LED tube lamp, wherein the lamp of claim 1 is configured for engagement with a linear fluorescent light fixture.

4. The LED tube lamp, wherein the cover of claim 1 comprises fins for increasing convective heat transfer.

5. The LED tube lamp, wherein the base of claim 1 defines a pair of outer grooves, and the cover comprises ribs shaped and sized to seat within the outer grooves.

6. The LED tube lamp, wherein the cover of claim 1 defines a diffusion pattern for diffusion of light emitted from the lighting circuit.

7. The LED tube lamp, the wherein the connector of claim 1 is a miniature bi-pin connector (G5), a medium bi-pin (G13) connector, a slim-line single pin (FA8) connector, a four-pin (2G11) connector, or a recessed double contact (R17d) connector.

8. The LED tube lamp, wherein the lamp of claim 1 is sized and shaped to correspond with linear fluorescent standard size T-4, T-5, T-8, T-10, or T-12.

9. The LED tube lamp, wherein the driver of claim 1 includes a pulse width modulation circuit or TRIAC circuit for dimming of the lighting circuit.

10. The LED tube lamp of claim 1, further comprising a backup power source.

11. The LED tube lamp of claim 1, further comprising identification indicia on end connectors.

12. The LED tube lamp of claim 1, the lighting circuit comprising:
a circuit board having a plurality of LED's configured with twelve LED's to a series.

13. The LED tube lamp of claim 12, wherein the circuit board comprises a plurality of parallels having 20 mA per parallel.

14. The LED tube lamp of claim 12, wherein the circuit board comprises a plurality of parallels having 18.5 mA per parallel.

15. The LED tube lamp of claim 12, wherein the circuit board comprises a plurality of parallels having 18 mA per parallel.

16. The LED tube lamp of claim 12, wherein the circuit board comprises a range of LED's of about 120 pieces to about 672 pieces.

17. The LED tube lamp of claim 1, wherein the cover comprises a photo luminescent material.

18. A system for replacement of a linear fluorescent bulb in a light fixture, comprising:
a base defining a channel;
a driver mounted within the channel;
a lighting circuit removeably attached to the base and operatively connected to the driver;
a cover removeably attached to the base; and
a connector removeably attached to the base and cover, the connector being operatively connected to the lighting circuit and the driver, and adapted for connection to the light fixture.
